(19) United States
(12) Patent Application Publication
(10) Pub. No.: US 2018/0126328 A1
(43) Pub. Date: May 10, 2018

(54) METHODS AND APPARATUSES FOR FUEL GAS CONDITIONING VIA MEMBRANES

(71) Applicant: UOP LLC, Des Plaines, IL (US)

(72) Inventors: Lubo Zhou, Inverness, IL (US); Parag Jain, Schaumburg, IL (US)

(21) Appl. No.: 15/866,377

(22) Filed: Jan. 9, 2018

Related U.S. Application Data
(63) Continuation of application No. PCT/US2016/040519, filed on Jun. 30, 2016.
(60) Provisional application No. 62/190,521, filed on Jul. 9, 2015.

(51) Int. Cl. B01D 53/22; B01D 63/12; B01D 71/16; B01D 71/24; C10L 3/10

(52) U.S. Cl. CPC B01D 53/226; B01D 63/12; B01D 71/16; B01D 71/24; C10L 3/101; C10L 2290/548; B01D 2053/223; B01D 2313/08; B01D 2317/08; B01D 2317/06; B01D 2317/022; C10L 3/104

(57) ABSTRACT

A method for conditioning natural gas into fuel gas, where the method includes the step of: delivering a natural gas stream including both CO₂ and C2+ hydrocarbons to a membrane separation assembly; and separating the natural gas stream into the following streams: (i) a first permeate stream, (ii) a second permeate stream, and (iii) a residual stream. The first permeate stream includes CO₂ removed from the natural gas stream. The second permeate stream includes methane at a greater concentration than a concentration of methane in the natural gas stream. The residual stream contains C2+ hydrocarbons at a greater concentration than a concentration of C2+ hydrocarbons in the natural gas stream.

### CROSS-REFERENCE TO RELATED APPLICATIONS

This application is a Continuation of International Application No. PCT/US2016/040519 filed June. 30, 2016, which application claims benefit of U.S. Provisional Application No. 62/190,521 filed Jul. 9, 2015, now expired, the contents of which cited applications are hereby incorporated by reference in their entirety.

### FIELD OF THE INVENTION

The present invention relates to a process for removing heavy hydrocarbons and carbon dioxide from natural gas. More particularly, the invention relates to an efficient design and process to remove heavy hydrocarbons and carbon dioxide from natural gas, while increasing the methane concentration in the gas, via a membrane separation unit.

### BACKGROUND OF THE INVENTION

A large fraction of the world's total natural gas reserves requires treating before it can be transported or used as feed stock or fuel gas. For example, the presence of hydrogen sulfide is problematic as it is both highly toxic and tends to embrittle steel pipelines. The presence of water can present transportation problems and in combination with carbon dioxide, lead to corrosion issues. The presence of heavy hydrocarbons can result in condensation issues and a too high heating value. Other natural gas reserves are poor in quality because the methane and other combustible gas components are diluted with non-combustible carbon dioxide and nitrogen gas, making the unrefined gas a relatively low Btu fuel source.

If the natural gas deposits contain high percentages of carbon dioxide and hydrogen sulfide, the gas is considered both poor and sour. Natural gas usually contains a significant amount of carbon dioxide. The proportion of carbon dioxide can range up to 70% by mole or higher, often from 5 to 40% by mole. A typical sour natural gas can, for example, contain 50 to 70% by mole of methane, 2 to 10% by mole of ethane, 0 to 5% by mole of propane, 0 to 20% by mole of hydrogen sulfide and 0 to 30% by mole of carbon dioxide. By way of example, the natural gas to be treated can contain 70% by mole of methane, 2% by mole of ethane, 0.7% by mole of propane, 0.2% by mole of butane, 0.7% by mole of hydrocarbons with more than four carbon atoms, 0.3% by mole of water, 25% by mole of carbon dioxide, 0.1% by mole of hydrogen sulfide and various other compounds as traces.

Natural gas can be a good source for fuel to generate electricity. However, reciprocating engines require a certain quality of the fuel to operate at high efficiency. For example, a reciprocating engine may require a fuel with a high heating value, such as 1030 BTU/scf. At the same time, methane content, which is measured by methane number in the industry, is also critical for engine efficiency. The higher the methane content, or methane number, the better the efficiency will be. For example, the typical range for an acceptable methane number for fuels for high performance reciprocating gas engines is between about 55 and about 85.

Raw natural gas may contain both carbon dioxide (CO₂) and heavy hydrocarbons (C2+). The CO₂ reduces the heating value of the fuel, and heavy hydrocarbons significantly reduce the methane number of the fuel. On the other hand, the heavy hydrocarbons increase the heating value of the fuel beyond the acceptable range, and can cause engine knocking effects. Thus, it is often desirable to remove the CO₂ and the heavy hydrocarbons from the fuel so that it can be used as a good quality fuel in the desired component, such as a reciprocating engine.

There are a number of different methods that have been used to treat natural gas streams. In most methods, a combination of technologies is employed to remove condensable components as well as gaseous components such as carbon dioxide. In one process, adsorbents are used to remove heavy hydrocarbons. In another process, refrigeration is used to remove heavy hydrocarbons. In yet another process, an amine solvent is used to remove carbon dioxide and hydrogen sulfide. Another particularly useful method involves permeable membrane processes and systems that are known in the art and have been employed or considered for a wide variety of gas and liquid separations. In such operations, a feed stream is brought into contact with the surface of a membrane, and the more readily permeable component of the feed stream is recovered as a permeate stream, with the less-readily permeable component being withdrawn from the membrane system as a non-permeate stream.

Membranes are widely used to separate permeable components from gaseous feed streams. Examples of such process applications include removal of acid gases from natural gas streams, removal of water vapor from air and light hydrocarbon streams, and removal of hydrogen from heavier hydrocarbon streams. Membranes are also employed in gas processing applications to remove permeable components from a process gas stream.

Membranes for gas processing typically operate in a continuous manner, wherein a feed gas stream is introduced to the membrane gas separation module on a non-permeate side of a membrane. In most natural gas membrane applications, the feed gas is introduced at separation conditions which include a separation pressure and temperature which retains the components of the feed gas stream in the vapor phase, well above the dew point of the gas stream, or the temperature and pressure condition at which condensation of one of the components might occur.

More specifically, such membrane separations are generally based on relative permeabilities of various components of the fluid mixture, resulting from a gradient of driving forces, such as pressure, partial pressure, concentration, and/or temperature. Such selective permeation results in the separation of the fluid mixture into portions commonly referred to as “residue,” “residue stream,” “residual,” “residual stream,” or “retentate,” e.g., generally composed of components that permeate more slowly; and “permeate,” or “permeate stream,” e.g., generally composed of components that permeate more quickly.

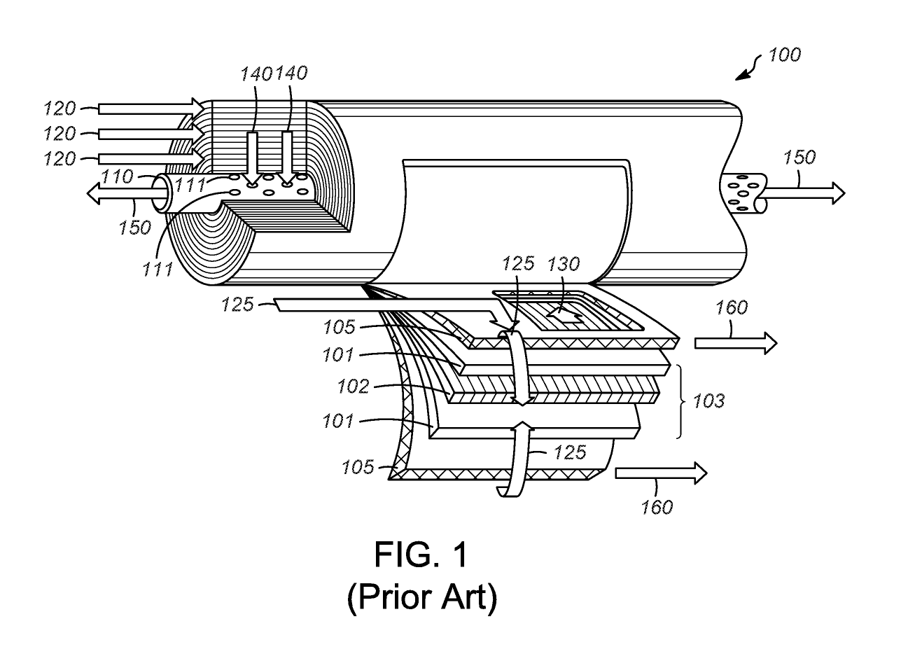

Separation membranes are commonly manufactured in a variety of forms, including flat-sheet arrangements and hollow-fiber arrangements, among others. In a flat-sheet arrangement, the sheets are typically combined into a spiral wound element. An exemplary flat-sheet, spiral-wound membrane element 100, as depicted in FIG. 1, includes two or more flat sheets of membrane 101 with a permeate spacer 102 in between that are joined, e.g., glued along three of their sides to form an envelope 103, i.e., a “leaf,” that is open at one end. The envelopes can be separated by feed spacers 105 and wrapped around a mandrel or otherwise wrapped around a permeate tube 110 with the open ends of the envelopes facing the permeate tube. Feed gas 120 enters along one side of the membrane element and passes through the feed spacers 105 separating the envelopes 103. As the gas travels between the envelopes 103, highly permeable compounds permeate or migrate into the envelope 103, indicated by arrow 125. These permeated compounds have only one available outlet: they must travel within the envelope to the permeate tube 110, as indicated by arrow 130. The driving force for such transport is the partial pressure differential between the low permeate pressure and the high feed pressure. The permeated compounds enter the permeate tube 110, such as through holes 111 passing through the permeate tube 110, as indicated by arrows 140. The permeated compounds then travel through the permeate tube 110, as indicated by arrows 150, to join the permeated compounds from other membrane elements that may be connected together in a multi-element assembly. Components of the feed gas 120 that do not permeate or migrate into the envelopes, i.e., the residual, leave the element through the side opposite the feed side, as indicated by arrows 160.

Typically, the permeate stream 150 is a single stream (although it can be travelling in two different directions (FIG. 1)), that includes gas with the same highly permeable compounds, such as natural gas with a certain group of compounds removed, such as with the heavy hydrocarbons removed.

However, there is a need for natural gas conditioning methods and apparatuses in which in which more than one type of compound can be easily and efficiently removed from a raw natural gas stream. For example, there is a need for natural gas conditioning methods and apparatuses that remove both carbon dioxide (CO₂) and heavy hydrocarbons (C2+) easily and efficiently, so that the resulting fuel can be used in a component such as a reciprocating engine.

### SUMMARY OF THE INVENTION

Aspects of the invention relate to a method for conditioning natural gas into fuel gas, where the method includes the step of: delivering a natural gas stream including both CO₂ and C2+ hydrocarbons to a membrane separation assembly; and separating the natural gas stream into the following streams: (i) a first permeate stream, (ii) a second permeate stream, and (iii) a residual stream. The first permeate stream includes CO₂ removed from the natural gas stream. The second permeate stream includes methane at a greater concentration than a concentration of methane in the natural gas stream. The residual stream contains C2+ hydrocarbons at a greater concentration than a concentration of C2+ hydrocarbons in the natural gas stream.

Aspects of the invention also relate to method for conditioning natural gas into fuel gas, where the method includes delivering a natural gas stream including both CO₂ and C2+ hydrocarbons to a membrane separation assembly; passing the natural gas stream through a first separating zone, which includes at least one first membrane element, to create a first permeate stream and a first zone residual stream; and passing the first zone residual stream through a second separating zone, which includes at least one second membrane element, to create a second permeate stream and a second zone residual stream. The first permeate stream includes CO₂ removed from the natural gas stream. The first zone residual stream is a gas stream that includes a lesser concentration of CO₂ than a concentration of CO₂ in the original natural gas stream. The second permeate stream is a natural gas stream that includes comprises methane at a greater concentration than a concentration of methane in the original natural gas stream. The second zone residual stream contains C2+ hydrocarbons at a greater concentration than a concentration of C2+ hydrocarbons in the original natural gas stream.

Aspects of the invention also relate to a membrane separation assembly module that includes first and second separating zones, with at least one first membrane element provided in the first separating zone, wherein the at least one first membrane element is CO₂ permeable, and a first permeate tube section within the first separating zone, wherein said first permeate tube section is configured and arranged to receive a first permeate, including CO₂, which has been permeated through the at least one first membrane. There is also at least one second membrane element in the second separating zone, wherein the at least one second membrane element is CH₄ permeable; and there is a second permeate tube section within the second separating zone, wherein said second permeate tube section is configured and arranged to receive a second permeate, including CH₄, which has been permeated through the at least one second membrane. The first permeate tube section and the second permeate tube section are configured and arranged such that a first permeate stream formed within said first separating zone does not pass through the second permeate tube section.

### DETAILED DESCRIPTION OF THE DRAWINGS

One or more exemplary embodiments of the present invention will be described below in conjunction with the following drawing figures, in which:

FIG. 1 is a schematic exploded view of a membrane element arrangement;

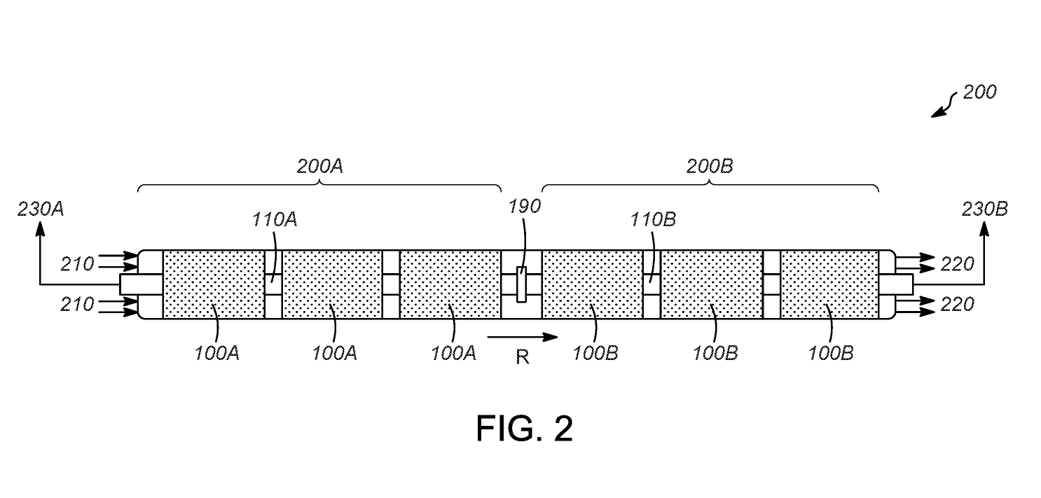

FIG. 2 is a schematic of a membrane separation assembly module of the present invention;

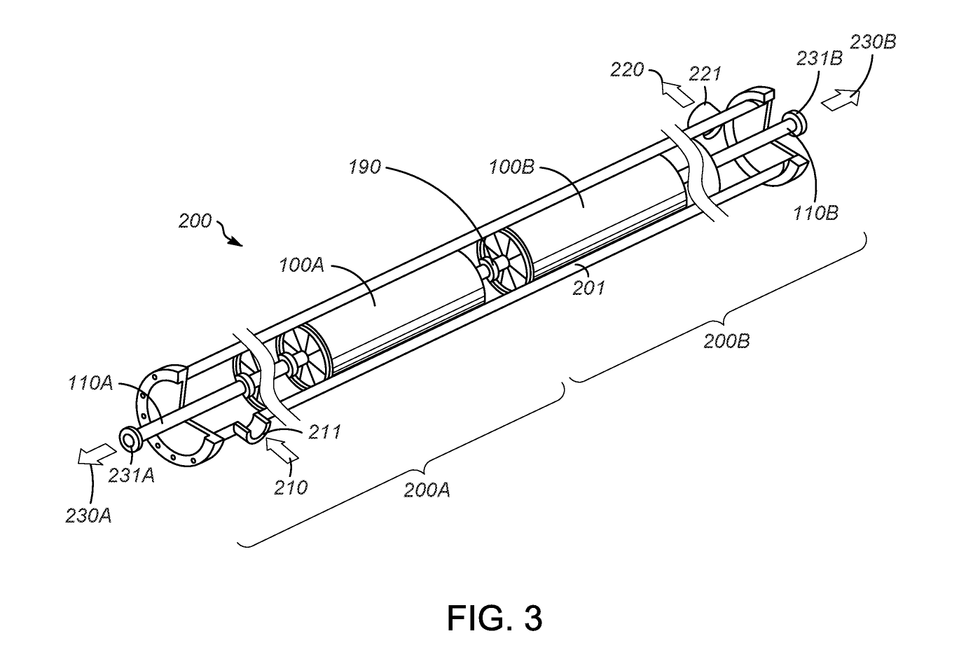

FIG. 3 is a perspective view of an embodiment of the membrane separation assembly module of FIG. 2; and

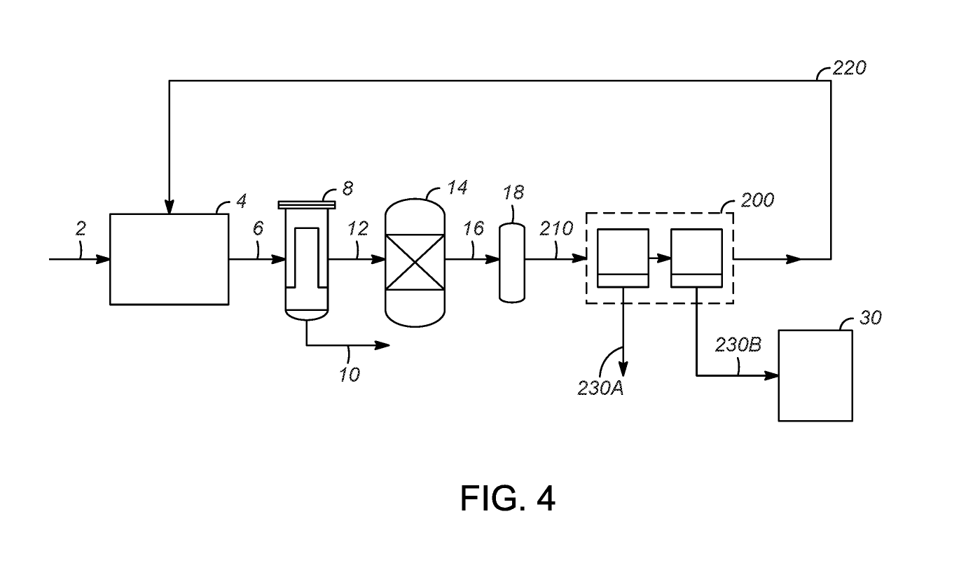

FIG. 4 is a process flow diagram of one example of an embodiment of a process into which the membrane assembly module of the present invention may be incorporated.

### DETAILED DESCRIPTION OF THE INVENTION

Embodiments of the invention disclosed herein relate to the use membranes, within a single vessel, for simultaneously removing both CO₂ and heavy hydrocarbons (C2+

from raw natural gas to generate a high methane number fuel for use in a fuel powered component, such as a reciprocating engine for electricity generation. In certain embodiments of the present assembly, there are CO₂ removal membranes and heavy hydrocarbon removal membranes that are connected in the same membrane housing tube or vessel. The membranes within a first separation zone will first remove CO₂ from the raw gas, and then, the membranes within a second separation zone will permeate methane from the feed gas stream. The final residue from the membrane system will be heavy hydrocarbons with high pressure.

In a traditional spiral wound membrane assembly, the membrane elements are connected to each other by the central permeate tube so that feed can flow through one membrane to another to achieve the objective of acid gas removal. In the present invention, there are two zones, a first separation zone and a second separation zone, where the flow of the permeate between a permeate tube section of the first zone, which is the CO₂ removal section, and the permeate tube section of the second zone, which is the methane permeate section, is blocked (or spaced apart) so that CO₂ permeated within the first zone will not flow to the methane that has been permeated within the second zone.

The membrane system of the present invention could be used for treating raw natural gas that has both CO₂ and C2+ heavy hydrocarbons when this raw gas is intended to be used to power another component, such as a component to generate power. The heating value and methane number are important parameters to optimize by the treatment.

Turning now to FIGS. 2 and 3, an example of an embodiment of the present membrane separation assembly module 200, or membrane separator, is shown and will be described, where FIG. 2 is a schematic drawing of module 200, and FIG. 3 is a perspective, cut-away view of one example of a structure for module 200. Of course it should be noted that the FIG. 3 view is but one example of such structure, and that other structures may also be made according to the principals set forth in the schematic of FIG. 2.

FIG. 2 shows how the membrane assembly module 200 can be considered as being divided into two separating zones—a first separating zone 200A and a second separating zone 200B. The first separating zone 200A includes at least one first membrane element 100A, and the second separating zone 200B includes at least one second membrane element 100B, with three of each membrane element 100A, 100B, for a total of six elements, being shown in FIG. 2. However, it is contemplated that there could be as few as one of each the first membrane element 100A and the second membrane element 100B, or more than one of each of the elements 100A and 100B, up to perhaps 20, or more, of each of the elements 100A and 100B being provided within a single membrane assembly module 200. Further, although FIG. 2 depicts membrane elements 100A and 100B being provided in the same number (three of each in this example), it is contemplated that a greater number of first membrane elements 100A than second membrane elements 100B could be provided, or vice versa.

In certain embodiments, both types of membrane elements, 100A and 100B, are structured as spiral-wound membrane elements, such as element 100 depicted in FIG. 1. However, it is contemplated that spiral wound membrane elements of structures different from that of FIG. 1 could also be utilized, or that membrane elements of types besides spiral wound could also be utilized.

In the membrane assembly module 200 of FIGS. 2 and 3, the goal of the first separating zone 200A is to separate CO₂ from a raw natural gas feed, and the goal of the second separating zone 200B is to separate high methane (CH₄) content natural gas from the heavy hydrocarbons (C2+). Thus, each the first membrane element(s) 100A in the first separating zone 200A is CO₂ permeable, such as certain membrane elements of the glassy polymer type (e.g., cellulose acetate based membranes), and each the second membrane element(s) 100B in the second separating zone 200B is CH₄ permeable, such as certain membrane elements of the glassy polymer type or of the rubber type (e.g., cellulose acetate based membranes or polydimethylsiloxane materials based membranes, respectively).

In operation, the membrane assembly module 200 of FIGS. 2 and 3 is used in a method for conditioning natural gas into fuel gas, where the method includes delivering a natural gas stream 210, which includes both CO₂ and C2+ hydrocarbons, to the membrane separation assembly module 200. The natural gas stream 210 may be delivered via a single inlet port, or via multiple inlet ports, or multiple natural gas streams may be combined and delivered to the module 200. While in the first separating zone 200A, the natural gas steam 210 passes through the one or more first membrane element(s) 100A, thereby forming a first permeate stream 230A from a first permeate that enters a first section 110A of a permeate tube. Since the first membrane element(s) 100A have been chosen to selectively allow CO₂ to pass therethough, the first permeate stream 230A is a gas that includes, among other components, the CO₂ removed from the natural gas stream 210. For example in certain embodiments, the percent CO₂ removal (i.e., the ratio of: (i) the difference between the CO₂ composition of the natural gas stream 210 and the first residual stream of first separating zone 200A to (ii) the CO₂ composition in the natural gas stream 210) may vary from between about 5% to about 90%.

The first residual stream from the first separating zone 200A, which generally travels in the direction R shown in FIG. 2, then passes into the second separating zone 200B. Since this first residual stream has had at least a portion, and preferably a significant amount, of the CO₂ removed, this first residual stream will include a lesser concentration of CO₂ than the concentration of CO₂ in the original natural gas stream 210.

Although the first residual stream is free to pass from the first separating zone 100A into the second separating zone 200B, one of the important features of the present invention is that the first permeate stream 230A, within the first section 110A of the permeate tube, is not permitted to pass from the first separating zone 200A into a second section 110B of the permeate tube, where the second section 110B is within the second separating zone 200B. Thus, a zone block 190 is provided between the first section 110A of the permeate tube and the second section 110B of the permeate tube. The zone block 190 may be any desired structure that prevents permeate stream passage between permeate tube sections 110A and 110B of a single permeate tube, such as a permanent wall or cap, or a valve that may be closed. It is also contemplated that the permeate tube could consist of two separate permeate tubes, where there is a cap on each of the permeate tubes sections 110A and 110B facing the gap between sections, thereby preventing direct communication between permeate tube sections 110A and 110B.

In the second separating zone 200B, the first residual stream, which now has a reduced amount of CO₂, passes through the one or more second membrane element(s) 100B, thereby forming a second permeate stream 230B from the second permeate that enters the second section 110B of the permeate tube. Since the second membrane element(s) 100B have been chosen to selectively allow CH₄ to pass therethough, while limiting or preventing heavy hydrocarbons (C2+) from passing therethrough, the second permeate stream 230B is the desired fuel gas that consists of natural gas with a greater concentration of CH₄ than a concentration of CH₄ in the original feed natural gas stream 210. In certain embodiments, the CH₄ concentration may typically increase from about 40-80% in the natural gas feed to about 60-95% in the second permeate stream 230B. The permeate pressure of the streams 230A and 230B may be between 0 psig to about 200 psig, depending on gas engine requirements and the destination of the CO₂ rich stream and the temperatures may range in between about 50° F. to about 150° F.

The second permeate stream 230B should have a high methane number (such as between 55 and 85), a low content of heavy hydrocarbons (C2+), and an appropriate heating value (such as between about 1000 BTU/scf and about 1150 BTU/scf and especially around 1030 BTU/scf), and thus it can be delivered as fuel gas to a component, such as a reciprocating engine, which could be used for any desired purpose, such as to generate electricity.

In addition to the second permeate stream 230B, a second residual stream 220 (or streams) also passes out of the second separating zone 200B. Since, as mentioned above, the second membrane element(s) 100B have been chosen to limit or prevent heavy hydrocarbons (C2+) from passing therethrough, the second residual stream 220 contains C2+ hydrocarbons at a greater concentration than a concentration of C2+ hydrocarbons in the natural gas stream 210.

Turning now to FIG. 3, an example of a structural device based on the concepts depicted in the schematic of FIG. 2 will be briefly described. It should be noted that FIG. 3 is only an example of one type of structure, and that other structures for performing the concepts depicted in FIG. 2 are also contemplated as being within the scope of the invention. FIG. 3 shows first membrane element(s) 100A, of the first separation zone 200A, and second membrane element(s) 100A, of the second separation zone 200B, provided within a module or housing 200, e.g., a tube 201.

The module 200 has an input (e.g., feed) stream 210, which in this case is a natural gas stream including both CO₂ and C2+ hydrocarbons, that enters through a feed port 211. The module 200 also includes an output or residual stream 220 that contains the substances which did not permeate through the membrane separation elements 100A and 100B, and that exit through a residual port 221. Further, the module 200 forms a first permeate stream 230A that contains the substances that permeate through the first membrane separation element 100A, within the first separating zone 200A, and that exit through a first permeate port 231A at one end of the first section 110A of the permeate tube. The module 200 also forms a second permeate stream 230A that contains the substances that permeate through the second membrane separation element 100B, within the second separating zone 200B, and that exit through a second permeate port 231B at the end of the second section 110B of the permeate tube.

In certain embodiments, the tube 201 can range in size from about 6 inches to about 24 inches (or with metric components, about 15 cm to 60 cm) in diameter, and is typically about 8 or about 12 inches (or with metric components, about 20 cm or 150 cm) in diameter. The ports 211, 221, and 231 can range in size from about 1 inch to about 4 inches (or with metric components, about 2.5 cm to about 10 cm) in diameter, and are typically about 2 or 3 inches in diameter (or with metric components, about 5 cm or about 7.5 cm). Feed and residual connections can also be located in the center of the tube in other combinations. The tube 201 and port elements 211, 221, 231A and 231B are conventionally made of steel, a relatively heavy metal, to withstand the pressures encountered during operations which are typically from about 300 psig to about 1,500 psig or higher (about 2068.4 kPa to about 10,342.125 kPa). It should be noted that multiple modules 200 could be provided in parallel to each other to process larger amounts of natural gas.

Turning now to FIG. 4, one example of a pretreatment system, which utilizes the present membrane separation module 200, is shown and will be described. It should be noted that the system of FIG. 4 is just one example of a system incorporating module 200, and that other pretreatment systems are also contemplated for use with the present membrane separation module 200, such as the system described in co-pending application Ser. No. 14/686,434, filed on Apr. 14, 2015, which is hereby incorporated by reference in its entirety.

FIG. 4 illustrates an exemplary system suitable for use in a fuel gas conditioning method including the membrane assembly module 200 of the present invention. As shown in FIG. 4, an initial feed source 2 of natural gas is provided to a compressor unit 4. The compressor unit 4 functions to increase the pressure of the gas to facilitate its transportation through a network of pipelines to further processing stages. Further, some applications require compression equipment to assist producers in removing potential liquids, as well as to provide fuel for the compression systems and other fuel gas users such as stabilizers, line heaters, and dehydration equipment. In compressor unit 4, the feed gas is first compressed to a pressure of about 5.5×10⁶ Pa (about 800 psi) to about 8.3×10⁶ Pa (about 1200 psi), for example about 6.9×10⁶ Pa (about 1000 psi), and then cooled to a temperature of about 38° C. (about 100° F.) to about 60° C. (about 140° F.), for example about 49° C. (about 120° F.), before entering a pretreatment system via stream 6, which is typically required upstream of membrane separators.

The pretreatment system can include, for example, a filter coalescer 8, a guard bed 14, and a particle filter 18. Further, a pre-heater (not shown) may optionally be included just after the filter coalesce 8. The filter coalescer 8 may be employed to remove any aerosol liquid components (including heavier hydrocarbons and/or entrained lube oil from compressor) or gaseous water (referred to as “mist”) that may be present in the natural gas stream. Exemplary gas/liquid filter coalescers are known in the art, having efficiencies that are typically greater than or equal to about 99.98%. The liquids and mist exits filter coalescer 8 via stream 10, with the fuel gas continuing through the pre-treatment system via stream 12.

The guard bed 14, which in an embodiment is a non-regenerative activated carbon guard bed, functions to remove any contaminants, such as lube oil, from the gas stream, such as may have been introduced from the pipeline, compressor, and/or other external sources. The decontaminated fuel gas flows from the guard bed 14 via stream 16, whereafter it is introduced into particle filter 18. Particle filter 18 functions to remove fine particles from the fuel gas that might have been entrained from the upstream activated carbon guard bed 14. The filtered fuel gas thereafter exits the pre-treatment system and travels via stream 210 to membrane separation assembly module (membrane separator) 200. If included, the optional pre-heater provides heat to raise the temperature of the natural gas stream to a desired operating temperature for introduction into the membrane separator (such temperature being determined by the particular type of separator employed, as is known in the art).

Reference will now be made to the membrane separator 200. Membrane separations performed within separator 200 are generally based on relative permeabilities of various components of the fluid mixture, resulting from a gradient of driving forces, such as pressure, partial pressure, concentration, and/or temperature. As mentioned above, such selective permeation results in the separation of the fluid mixture into portions commonly referred to as “residue,” “residual” or “retentate”, e.g., generally composed of components that permeate more slowly; and “permeate”, e.g., generally composed of components that permeate more quickly.

Membranes for gas processing typically operate in a continuous manner, wherein a feed gas stream is introduced to the membrane gas separation module on a non-permeate side of a membrane. The feed gas is introduced at separation conditions which include a separation pressure and temperature that retains the components of the feed gas stream in the vapor phase, well above the dew point of the gas stream, or the temperature and pressure condition at which condensation of one of the components might occur.

After pretreatment, the gas enters the membrane separator 200 via line 210. As described above, the two separation zones of the membrane separator 200 separate the gas into heavier hydrocarbon rich residue (non-permeate) stream 220, a first permeate stream 230A and a second permeate stream 230B. The residue gas stream 220 can be recycled back to re-join the unconditioned natural gas stream. For example, in one embodiment, the residue stream 220 is delivered back to a compression inter-stage of the compressor 4 to comingle back with the feed source of natural gas (feed source 2 as it is compressed in the compressor 4).

The second permeate stream 230B is available at, for example, about 3.4×10⁵ Pa (about 50 psi) to about 1.0×10⁶ Pa (about 150 psi), such as about 6.9×10⁵ Pa (about 100 psi), and can be used as fuel directly for one or more components 30, such as a reciprocating engine for generating electricity, as described above. Component 30 can also be, for example, another component of the natural gas transportation and processing assembly that requires fuel gas.

Furthermore, the permeate gas could also be directed back to the engine of compressor 4 to provide fuel to the engine of compressor 4.

The membrane housing structure, referred to as the “skid,” can be made using the conventional valving and housings as a typical gas membrane separation plant used in sour gas service, known in the art. The pretreatment system, including the coalescer, particle filter, guard bed, and heater is applied as necessary, and will depend on the characteristics of the feed gas source, as is known in the art. The permeate gas stream 230B will be used as fuel directly to the reciprocating engine, and other components. The inlet to the membrane can be modulated as well as the back-pressure on the membrane permeate flow in order to control and maintain a steady heating value to the compressor.

It should be appreciated and understood by those of ordinary skill in the art that various other components such as valves, pumps, filters, coolers, etc. are not shown in the drawings as it is believed that the specifics of same are well within the knowledge of those of ordinary skill in the art and a description of same is not necessary for practicing or understating the embodiments of the present invention.

### Specific Embodiments

While the following is described in conjunction with specific embodiments, it will be understood that this description is intended to illustrate and not limit the scope of the preceding description and the appended claims.

A first embodiment of the invention is a method for conditioning natural gas into fuel gas, the method comprising delivering a natural gas stream including both CO₂ and C2+ hydrocarbons to a membrane separation assembly; and separating the natural gas stream into (i) a first permeate stream, (ii) a second permeate stream, and (iii) a residual stream, wherein the first permeate stream comprises CO₂ removed from the natural gas stream, wherein the second permeate stream comprises methane at a greater concentration than a concentration of methane in the natural gas stream, and wherein the residual stream contains C2+ hydrocarbons at a greater concentration than a concentration of C2+ hydrocarbons in the natural gas stream. The method according to this embodiment may further comprise passing the first permeate stream though a first permeate tube section to a first permeate tube outlet; and passing the second permeate stream through a first permeate tube section to a second permeate tube outlet. The method may be performed wherein the first permeate tube section and the second permeate tube section comprise a single tube with a zone block device separating the first permeate tube section from the second permeate tube section. The method may be performed wherein the zone block device prevents direct communication between the first permeate tube section and the second permeate tube section. The method may be performed wherein the first permeate tube section and the second permeate tube section comprise two separate tubes. The method may further comprise delivering the second permeate stream to an engine for use as a fuel gas in the engine. The method may be performed wherein the step of forming the first permeate stream includes passing the natural gas stream through at least one first membrane; and the step of forming the second permeate stream includes passing a first residual stream through at least one second membrane, and further wherein the first membrane is comprised of a different material than the second membrane. The method may be performed wherein the step of forming the first permeate stream includes passing the natural gas stream through at least one first membrane; and the step of forming the second permeate stream includes passing a first residual stream through at least one second membrane, and further wherein the first membrane is comprised of the same material as the second membrane.

A second embodiment of the invention is a method for conditioning natural gas into fuel gas, the method comprising delivering a natural gas stream including both CO₂ and C2+ hydrocarbons to a membrane separation assembly; passing the natural gas stream through a first separating zone, which includes at least one first membrane element, to create a first permeate stream and a first zone residual stream; passing the first zone residual stream through a second separating zone, which includes at least one second membrane element, to create a second permeate stream and a second zone residual stream; wherein the first permeate stream comprises CO₂ removed from the natural gas stream, wherein the first zone residual stream comprises a lesser concentration of CO₂ than a concentration of CO₂ in the natural gas stream, wherein the second permeate stream comprises methane at a greater concentration than a concentration of methane in the natural gas stream, and wherein the second zone residual stream contains C2+ hydrocarbons at a greater concentration than a concentration of C2+ hydrocarbons in the natural gas stream. The method may include passing the first permeate stream though a first permeate tube section to a first permeate tube outlet; and passing the second permeate stream through a first permeate tube section to a second permeate tube outlet. The method may be performed wherein the first permeate tube section and the second permeate tube section comprise a single tube with a zone block device separating the first permeate tube section from the second permeate tube section. The method may be performed wherein the zone block device prevents direct communication between the first permeate tube section and the second permeate tube section. The method may be performed wherein the first permeate tube section and the second permeate tube section comprise two separate tubes. The method may include delivering the second permeate stream to an engine for use as a fuel gas in the engine. The method may be performed wherein the at least one first membrane element is comprised of a different material than the at least one second membrane element.

Another embodiment is directed to a membrane separation assembly module comprising at least one first membrane element in a first separating zone, wherein the at least one first membrane element is CO₂ permeable; a first permeate tube section within the first separating zone, wherein the first permeate tube section is configured and arranged to receive a first permeate, including CO₂, which has been permeated through the at least one first membrane; at least one second membrane element in a second separating zone, wherein the at least one second membrane element is CH₄ permeable; and a second permeate tube section within the second separating zone, wherein the second permeate tube section is configured and arranged to receive a second permeate, including CH₄, which has been permeated through the at least one second membrane; wherein the first permeate tube section and the second permeate tube section are configured and arranged such that a first permeate stream formed within the first separating zone does not pass through the second permeate tube section. The membrane separation assembly module may further comprise a first permeate tube outlet for routing the first permeate out of the membrane assembly; a second permeate tube outlet for routing the second permeate out of the membrane assembly; and a residual outlet for routing residual gas out of the membrane assembly. The first permeate tube section and the second permeate tube section of this embodiment may comprise a single tube with a zone block device separating the first permeate tube section from the second permeate tube section. The first permeate tube section and the second permeate tube section of this embodiment may comprise two separate tubes. The at least one first membrane element may comprise a cellulose acetate based membrane; and the at least one second membrane element may comprise either a cellulose acetate based membrane or polydimethylsiloxane based membrane.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for conditioning natural gas into fuel gas, the method comprising:
delivering a natural gas stream including both CO₂ and C2+ hydrocarbons to a membrane separation assembly; and
separating the natural gas stream into:
(i) a first permeate stream,
(ii) a second permeate stream, and
(iii) a residual stream,
wherein the first permeate stream comprises CO₂ removed from the natural gas stream,
wherein the second permeate stream comprises methane at a greater concentration than a concentration of methane in the natural gas stream, and
wherein the residual stream contains C2+ hydrocarbons at a greater concentration than a concentration of C2+ hydrocarbons in the natural gas stream.

2. The method according to claim 1, further comprising:
passing said first permeate stream though a first permeate tube section to a first permeate tube outlet; and
passing said second permeate stream through a second permeate tube section to a second permeate tube outlet.

3. The method according to claim 2, wherein said first permeate tube section and said second permeate tube section comprise a single tube with a zone block device separating said first permeate tube section from said second permeate tube section.

4. The method according to claim 3, wherein said zone block device prevents direct communication between said first permeate tube section and said second permeate tube section.

5. The method according to claim 2, wherein said first permeate tube section and said second permeate tube section comprise two separate tubes.

6. The method according to claim 1, further comprising delivering the second permeate stream to an engine for use as a fuel gas in the engine.

7. The method according to claim 1, wherein:
said step of forming the first permeate stream includes passing the natural gas stream through at least one first membrane; and
said step of forming the second permeate stream includes passing a first residual stream through at least one second membrane, and
further wherein said first membrane is comprised of a different material than said second membrane.

8. The method according to claim 1, wherein:
said step of forming the first permeate stream includes passing the natural gas stream through at least one first membrane; and
said step of forming the second permeate stream includes passing a first residual stream through at least one second membrane, and
further wherein said first membrane is comprised of the same material as said second membrane.

9. A method for conditioning natural gas into fuel gas, the method comprising:
delivering a natural gas stream including both CO₂ and C2+ hydrocarbons to a membrane separation assembly;
passing the natural gas stream through a first separating zone, which includes at least one first membrane element, to create a first permeate stream and a first zone residual stream;
passing the first zone residual stream through a second separating zone, which includes at least one second membrane element, to create a second permeate stream and a second zone residual stream;
wherein the first permeate stream comprises CO₂ removed from the natural gas stream,
wherein the first zone residual stream comprises a lesser concentration of CO₂ than a concentration of CO₂ in the natural gas stream,
wherein the second permeate stream comprises methane at a greater concentration than a concentration of methane in the natural gas stream, and
wherein the second zone residual stream contains C2+ hydrocarbons at a greater concentration than a concentration of C2+ hydrocarbons in the natural gas stream.

10. The method according to claim 9, further comprising:
passing said first permeate stream though a first permeate tube section to a first permeate tube outlet; and
passing said second permeate stream through a first permeate tube section to a second permeate tube outlet.

11. The method according to claim 10, wherein said first permeate tube section and said second permeate tube section comprise a single tube with a zone block device separating said first permeate tube section from said second permeate tube section.

12. The method according to claim 11, wherein said zone block device prevents direct communication between said first permeate tube section and said second permeate tube section.

13. The method according to claim 10, wherein said first permeate tube section and said second permeate tube section comprise two separate tubes.

14. The method according to claim 9, further comprising delivering the second permeate stream to an engine for use as a fuel gas in the engine.

15. The method according to claim 9, wherein said at least one first membrane element is comprised of a different material than said at least one second membrane element.

16. A membrane separation assembly module comprising:
at least one first membrane element in a first separating zone, wherein said at least one first membrane element is CO₂ permeable;
a first permeate tube section within said first separating zone, wherein said first permeate tube section is configured and arranged to receive a first permeate, including CO₂, which has been permeated through said at least one first membrane;
at least one second membrane element in a second separating zone, wherein said at least one second membrane element is CH₄ permeable; and
a second permeate tube section within said second separating zone, wherein said second permeate tube section is configured and arranged to receive a second permeate, including CH₄, which has been permeated through said at least one second membrane;
wherein said first permeate tube section and said second permeate tube section are configured and arranged such that a first permeate stream formed within said first separating zone does not pass through said second permeate tube section.

17. The membrane separation assembly module according to claim 16, further comprising:
a first permeate tube outlet for routing the first permeate out of said membrane assembly;
a second permeate tube outlet for routing the second permeate out of said membrane assembly; and
a residual outlet for routing residual gas out of said membrane assembly.

18. The membrane separation assembly module according to claim 16, wherein said first permeate tube section and said second permeate tube section comprise a single tube with a zone block device separating said first permeate tube section from said second permeate tube section.

19. The membrane separation assembly module according to claim 16, wherein said first permeate tube section and said second permeate tube section comprise two separate tubes.

20. The membrane separation assembly module according to claim 16, wherein:
said at least one first membrane element comprises a cellulose acetate based membrane; and
said at least one second membrane element comprises either a cellulose acetate based membrane or polydimethylsiloxane based membrane.
